(19) United States
(12) Patent Application Publication
(10) Pub. No.: US 2010/0158319 A1
(43) Pub. Date: Jun. 24, 2010

(54) METHOD AND APPARATUS FOR FAKE-FACE DETECTION USING RANGE INFORMATION

(75) Inventors: Sung Uk Jung, Daejeon (KR); Yun Su Chung, Daejeon (KR); Ki Young Moon, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/509,825

(22) Filed: Jul. 27, 2009

(30) Foreign Application Priority Data
Dec. 22, 2008 (KR) 10-2008-0131785

(51) Int. Cl. G06K 9/68; G06K 9/46; G06K 9/00; H04N 13/02

(52) U.S. Cl. 382/106; 382/218; 382/201; 348/46; 348/E13.074

(57) ABSTRACT

A fake-face detection method using range information includes: detecting face range information and face features from an input face image; matching the face image with the range information; and distinguishing a fake face by analyzing the matched range information.

### CROSS-REFERENCE(S) TO RELATED APPLICATION(S)

The present invention claims priority of Korean Patent Application No. 10-2008-0131785, filed on Dec. 22, 2008, which is incorporated herein by reference.

### FIELD OF THE INVENTION

The present invention relates to a method and apparatus that distinguishes between a real face and a fake face like a photograph, and, more particularly, to a method and apparatus that detects a face by using camera and range data and distinguishes a fake face by analyzing detected range information of the face.

### BACKGROUND OF THE INVENTION

Recently, biometric recognition technology has been received a great deal of attention due to the following merits: (i) it is completely free from loss or memorization, since it is a personal recognition technology utilizing physical characteristics or behavior of a person; and (ii) it is more secure than conventional technologies using passwords, since the biometric information must be entered directly to the security system. In fact, biometric recognition technology is regarded as a next-generation technology that would replace the conventional personal authentication technologies based on passwords or identification cards.

With the rapid development in techniques counterfeiting biometric information, however, the problem of fake biometric information, introduced usually in the entering stage to the system, has been the most important factor affecting the credibility and security in biometric recognition, and, hence, conventional biometric recognition algorithms have great difficulties in distinguishing fake biometric information from the real information.

In the case of face recognition, an analysis of the thermal distribution on a face image photographed by a thermal infrared camera could provide the distinction between fake and real faces without a great difficulty. Despite their excellent performance, however, these cameras are so expensive that it is of little avail to employ them in most practical situations and its operation accompanies certain inconveniences of having to demand the user to talk or move in front of the camera. Considering that a face recognition system finds its principal applications in the area of security such as in an access control system for a premise, there is a great need to develop a safer, more accurate and less expensive technique to distinguish a fake face.

### SUMMARY OF THE INVENTION

In view of the above, the present invention provides a fake-face detection method and apparatus which, in order to distinguish a two-dimensional fake face image like a photograph from a real face, obtains range information of the face from a stereographic camera, range-measuring sensor or analysis of several face images and distinguishes a fake face from the face images entered in real time by using the range information.

In accordance with one aspect of the present invention, there is provided a fake-face detection method using range information, including:

detecting face range information and face features from an input face image;

matching said face image with said range information; and

distinguishing a fake face by analyzing said matched range information.

In accordance with another aspect of the present invention, there is provided a fake-face detection apparatus using range information, including:

a face-feature detection unit that detects positions of face features from an input face image;

a range-information extraction unit that extracts information about ranges to respective parts of said face image;

a matching unit that matches said face image with said range information; and

a fake-face distinction unit that distinguishes a fake face by analyzing said matched range information.

The present invention provides a fake-face detection method and apparatus that distinguishes a fake face by using the characteristics of a fake face like a photograph and carries out recognizing face images only when a fake face is not identified, yielding a face recognition system of highly enhanced security and credibility.

### BRIEF DESCRIPTION OF THE DRAWINGS

The present invention will become apparent from the following description of embodiments given in conjunction with the accompanying drawings, in which:

FIG. 1 shows a block diagram of a fake-face detection apparatus using range information in accordance with an embodiment of the present invention.

FIG. 2 shows a flowchart of a fake-face detection method in accordance with an embodiment of the present invention.

FIG. 3A shows how range data for a whole real face is calculated.

FIG. 3B shows how one-dimensional range data is calculated from a real face.

FIG. 4A shows how a fake face score is calculated when range data exist for a whole face.

FIG. 4B shows how a fake face score is calculated when range data are one-dimensional.

### DETAILED DESCRIPTION OF THE EMBODIMENTS

Hereinafter, embodiments of the present invention will be described in detail with reference to the accompanying drawings.

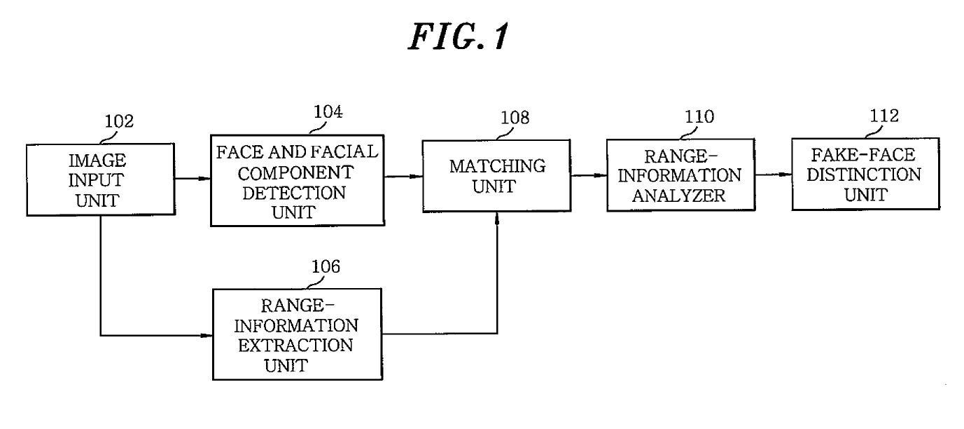

FIG. 1 shows a block diagram of a fake-face detection apparatus using range information in accordance with an embodiment of the present invention. The fake-face detection apparatus includes an image input unit 102, a face and facial component detection unit 104, a range-information extraction unit 106, a matching unit 108, a range-information analyzer 110 and a fake-face distinction unit 112.

The image input unit 102, including at least one camera that photographs a subject, converts input photograph images (or motion pictures) into digital signals and passes the corresponding digital image(s) to the face and facial component detection unit 104 and the range-information extraction unit 106. It should be mentioned that when a stereographic camera is used to take images, stereographic images are entered in the image input unit 102.

The face and facial component detection unit 104 detects a face area from the digital image(s) transmitted from the image input unit 102, detects face features such as the eyes, nose and mouth out of the detected face area and passes the detected information of face area and position information of the face features together with the photographed digital images to the matching unit 108.

The range-information extraction unit 106 includes a range measuring sensor and a range extraction module. In order to extract range information out of the digital image(s) transmitted from the image input unit 102, either the range measuring sensor is used to measure the range to the face area or the range extraction module is employed to analyze sequential images and the extracted range information is passed to the matching unit 108.

The matching unit 108 matches face features detected in the face and facial component detection unit 104 with the range information extracted in the range-information extraction unit 106. Here, matching of a face area is carried out by using a salient phenomenon that, nearing the bordering edge of a face area, the value of range data gets larger than that in any other parts. For example, the eyes and nose have values of the range data smaller than the bordering edge of the face area and a further comparison of the eyes and nose yields that the range data of the nose is smaller than that of the eyes.

The range-information analyzer 110 analyzes the matched range information passed from the matching unit 108 to calculate the fake-face score. Calculation of the fake-face score is carried out in a different manner depending on how the photographed images are authenticated. When a photographed image is authenticated as a two-dimensional image, the face features on the image are located all on a same plane in the space.

When the authentication is carried out as a three-dimensional image like a real face, then the procedure is more complicated since the respective range data of the face features are not on the same plane. In this case, the range information of the face features is used to derive an equation of a plane in the space and then the fake-face score can be obtained by the ranges of the face features from the derived plane. The fake-face score can be determined by any one of the ranges obtained in this manner or any one of the face features can be used for the reference point to calculate the ranges from other range information.

On the other hand, when the authentication is carried out for one-dimensional range information of the face features, the range information is used to derive an equation of a straight line in the space and the fake-face score is calculated based on the ranges of the face features from the derived straight line, i.e., lengths of the segments formed by a projection of the face features on the straight line at the right angle.

The fake-face distinction unit 112 compares the fake-face score calculated in the range-information analyzer 110 with the predetermined critical value and distinguishes a fake face. When the fake-face score is larger than the predetermined critical value, it is decided that the input image is a fake face. When the fake-face score is smaller than the predetermined critical value, however, it is decided that the input image is a real face and the decision output is produced accordingly.

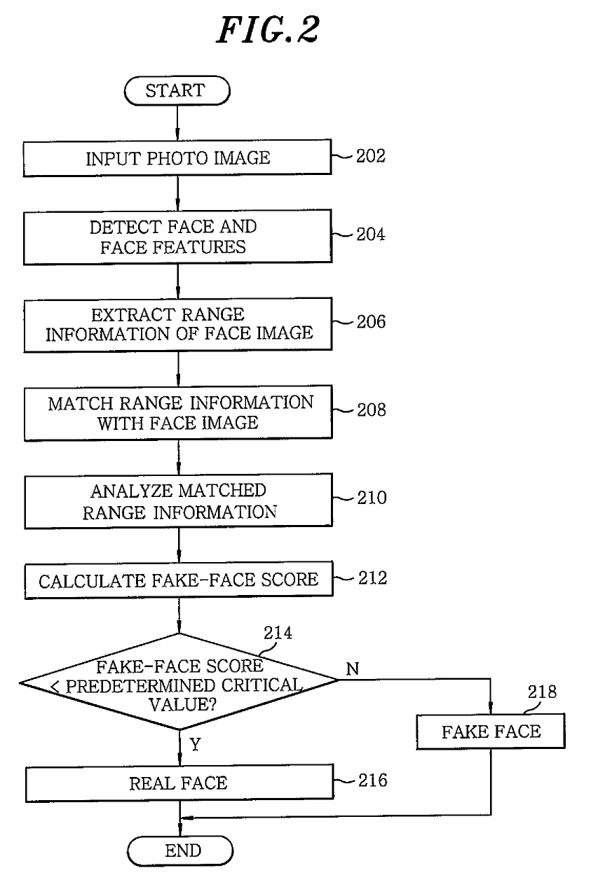

FIG. 2 shows a flowchart of whole procedures of a fake-face detection method in accordance with an embodiment of the present invention. In step 202, the procedure starts with entering an image taken by a camera in image input unit 102. When a stereographic camera is used, however, the stereographic image (left and right images) is entered in the image input unit 102. The fake-face detection unit detects in step 204 face features such as the whole face, eyes, nose and mouth from the input image.

In the next step 206, the range information is either calculated from the input image or extracted by using a range sensor 206. For example, images taken by a stereographic camera are analyzed or a range sensor is employed to calculate the range information. In other instances, sequential images from the image input unit 102 are analyzed to extract the range information.

In step 208, the positions of the face features obtained in step 204 are used to match the range information with the face image taken by the camera. The approximate positions of face features can be matched by taking into consideration the fact that the range information gets larger nearing the bordering edge of a face. The face features like the two eyes and a nose can be detected from the image as without great difficulty as they can be prominently determined from the range information. The nose has a relatively smaller value compared to other parts of a face, while the eyes have a relatively larger value.

The two range data matched in step 208 are analyzed in step 210. When the authentication is attempted for a photograph, the points on the image all lie on a plane in the space, but for a real face the range data do not lie on a plane since a face is inevitably three-dimensional. The results of analysis in step 210 are made use in calculating a fake-face score in step 212. When range information is provided for a whole face, an equation of a plane is derived with arbitrary range data and calculation of ranges from the plane to the other data points yields a fake-face score. When there is only one-dimensional information, an equation of a straight line is derived by using arbitrary range data and ranges from the line to the other data points are calculated to yield a fake-face score.

In step 214, the fake-face score calculated is compared with the predetermined critical value. If it is smaller than the critical value, then a decision is made that the input image is a real face in step 216; and if larger, it is considered to be a fake face in step 217.

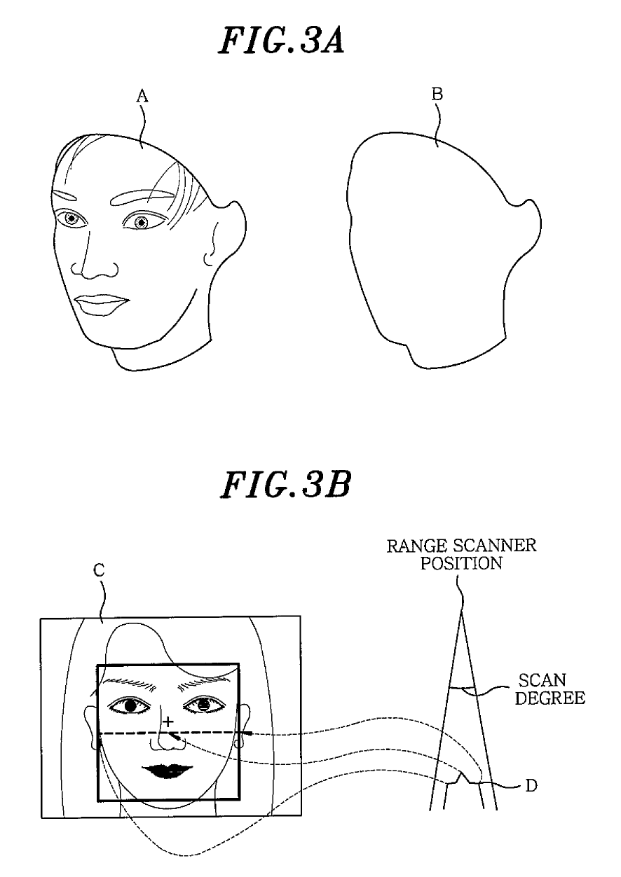

FIG. 3A shows how range data for a whole real face is calculated. FIG. 3B shows how one-dimensional range data is calculated from a real face.

The case an image of a real face A is entered is shown in FIG. 3A. Here, one can analyze either images from a range sensor or stereographic camera or sequential images to extract range information B about the whole face. It is can be found from information indicated by range information B that the range data of the two eyes, the nose and the edge of the face are different from each other. This property is used in matching the image from a camera and the range data of the whole face.

In the case the range data are of one-dimensional, shown in FIG. 3B, comparison of an image C from a camera with range information D expressed in one-dimensional form indicates that the range data of the nose is different from that of the face edge. This property is taken into consideration when the two inputs are matched.

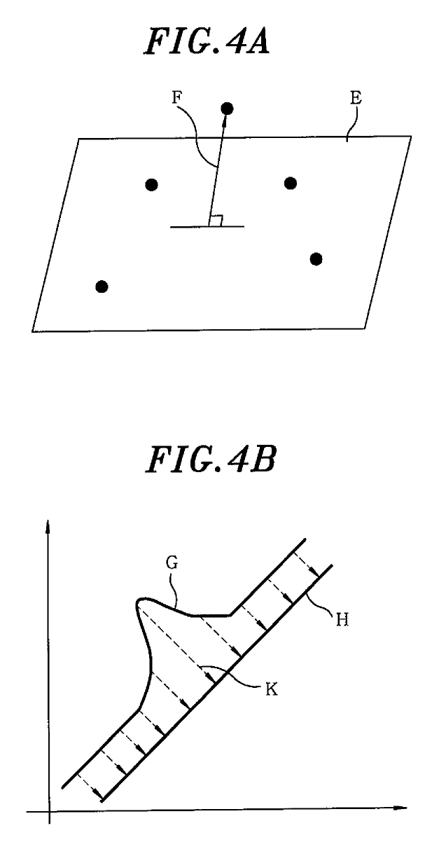

FIG. 4A shows how a fake face score is calculated when range data exist for a whole face. FIG. 4B shows how a fake face score is calculated when range data are one-dimensional.

When range data exist for a whole face, an equation for a plane E in the space is derived by using the range data and the fake-face score is calculated by the ranges F from the plane to the other points of the image. In other words, in the case a fake face is a two-dimensional image, like a photographed picture, there exist other range data on this plane and hence the fake-face score appears to be smaller, while for a real face, it shows a larger value.

When the range data are one-dimensional G, an equation of a straight line H can be derived from data points save the part around the nose. The fake-face score in this case is given by the ranges K determined by projecting the other data points to this line.

While the invention has been shown and described with respect to the embodiments, it will be understood by those skilled in the art that various changes and modifications may be made without departing from the scope of the invention as defined in the following claims.

What is claimed is:

1. A fake-face detection method using range information, comprising:
detecting face range information and face features from an input face image;
matching said face image with said range information; and
distinguishing a fake face by analyzing said matched range information.

2. The fake-face detection method of claim 1, wherein said detecting face features extracts positions of face features such as eyes, nose and mouth from said face image.

3. The fake-face detection method of claim 1, wherein said range information is extracted by one or more of a range sensor, a stereoscopic camera and an image sequence analyzer.

4. The fake-face detection method of claim 2, wherein said matching matches with said range information using said face features and said extracted positions and normalizes them.

5. The fake-face detection method of claim 1, wherein said detecting range information is carried out by a one-dimensional scan of a domain including one of said face features.

6. The fake-face detection method of claim 5, wherein said distinguishing a fake face forms a straight line from a selected part of said face image and distinguishes a fake face by ranges from said straight line to respective parts of said face image.

7. The fake-face detection method of claim 1, wherein said detecting range information is carried out by a two-dimensional scan of a whole domain of said face image.

8. The fake-face detection method of claim 7, wherein, if said range information is two-dimensional on said whole domain of said face image, said distinguishing a fake face forms a plane from a selected part of said face image and distinguishes a fake face by ranges from said plane to respective parts of said face image.

9. A fake-face detection apparatus using range information, comprising:
a face-feature detection unit that detects positions of face features from an input face image;
a range-information extraction unit that extracts information about ranges to respective parts of said face image;
a matching unit that matches said face image with said range information; and
a fake-face distinction unit that distinguishes a fake face by analyzing said matched range information.

10. The fake-face detection apparatus of claim 9, wherein said range-information extraction unit further includes one or more of a range sensor, a stereoscopic camera and an image sequence analyzer.

11. The fake-face detection apparatus of claim 10, wherein said range-information extraction unit carries out one or both of a one-dimensional scan of a domain including one of said face features and a two-dimensional scan of a whole domain of said face image.

12. The fake-face detection apparatus of claim 11, wherein said fake-face distinction unit, for the case of said one-dimensional scan, forms a straight line from a selected part of said face image, calculates a fake-face score using ranges from said straight line to respective parts of said face image and distinguishes a fake face from a comparison of said fake-face score with a predetermined critical value.

13. The fake-face detection apparatus of claim 11, wherein said fake-face distinction unit, for the case of said two-dimensional scan, forms a plane from a selected part of said face image, calculates a fake-face score using ranges from said plane to respective parts of said face image and distinguishes a fake face from a comparison of said fake-face score with a predetermined critical value.
